(19) United States
(12) Patent Application Publication
(10) Pub. No.: US 2024/0337411 A1
(43) Pub. Date: Oct. 10, 2024

(54) Axle Receptacle for an Air Flap Rotary Drive And Air Flap Rotary Drive

(71) Applicant: Siemens Schweiz AG, Zürich (CH)

(72) Inventor: Severin Wattenhofer, Meierskappel (CH)

(73) Assignee: Siemens Schweiz AG, Zürich (CH)

(21) Appl. No.: 18/623,409

(22) Filed: Apr. 1, 2024

(30) Foreign Application Priority Data
Apr. 5, 2023 (EP) 23166744.5

(51) Int. Cl. F24F 13/10

(52) U.S. Cl. CPC F24F 13/10

(57) ABSTRACT

Various embodiments of the teachings herein include an axle receptacle for fixing to an axle of an air flap. An example receptacle includes a tension bracket and a compression bracket that can be moved by means of a drive shaft relative to the tension bracket. The drive shaft is guided in a drive shaft guide in the tension bracket. The drive shaft and the drive shaft guide function as a quick-action clamping apparatus.

### CROSS-REFERENCE TO RELATED APPLICATIONS

This application claims priority to EP Application No. 23166744.5 filed Apr. 5, 2023, the contents of which are hereby incorporated by reference in their entirety.

### TECHNICAL FIELD

The present disclosure relates to actuator facilities. Various embodiments of the teachings herein include actuator facilities for an air flap or the like in a system for heating, ventilation, or cooling in a building (air flap rotary drive).

### BACKGROUND

An air flap rotary drive comprises a drive facility, usually an electric motor, means for force-fit contacting and form-fit contacting of an axle of an air flap (axle receptacle) and optionally a gear between the drive facility and the axle receptacle. Axle receptacles are known, for example from U.S. Pat. No. 6,505,991 B2 or US 2009/0052982 A1. The applicant offers its own axle receptacle under the product name GS MK2.

Known axle receptacles comprise a tension bracket and a compression bracket that is movable relative to the tension bracket, wherein the movement of the compression bracket takes place in the manner of a spindle drive by means of a rotatable drive shaft. Depending on the position of the compression bracket and depending on the circumference of the axle to be fixed in each case by means of the axle receptacle, a large number of rotations of the drive shaft are required. At least a plurality of rotations of the drive shaft is also required to release the fixing of an axle. This is time-consuming at the least.

Axle receptacles are also known in which the drive shaft and the drive shaft guide function as a quick-action clamping apparatus in that the drive shaft has a form-fitting contour in or on its outer surface and the drive shaft guide has a form-fitting mating contour in or on its inner surface. US 2022/106987 A1 describes an axle receptacle for an air flap rotary drive and an air flap rotary drive with such an axle receptacle, which has components on a tensioning side and compressing side that can move in opposite directions and in each case in the direction of an axle, and a tension bracket as a movable component on the tensioning side. For mobility of the tension bracket, a thread of the tension bracket engages with a thread of a nut, wherein the tension bracket has the thread in an upper part of the tension bracket and the thread begins there on an underside of the upper part of the tension bracket and ends below an upper side of the upper part of the tension bracket.

GB 2539395 A discloses a clamping mechanism with a nut, a clamp plate, a bolt and a block. The nut has an axial borehole with a thread embodied on an inner surface of the borehole. The bolt has a pair of arms and cross piece joining the arms together. The arms have a screw thread embodied on an outer surface of the arms and corresponding to the screw thread of the nut. The clamp plate has an elongate body narrower than the separation between the arms so as to fit between the arms. The block can be engaged with the nut for movement therewith, wherein the block extends between the arms of the bolt. The block opposes flexure of the arms toward each other when the nut is screwed onto the bolt.

GB 1396645 A describes a cable clamp with a substantially U-shaped clamp body and a clamping side that can engage therein, wherein the clamp body is formed from a stack of plates insulated from each other and held together by connecting means such as rivets. All plates have an identical shape and together form two mutually facing racks on the limbs of the body the teeth of which are bounded by straight lines. The clamping slide is provided on two opposite side faces with outwardly directed teeth that are engageable with the racks for securing the slide in the body in the cable clamping position.

EP 0282116 A1 discloses a branch terminal for connecting a main electrical branch conductor to a continuous electrical main conductor. The branch terminal comprises an electrically conducting contact block which can be fixed in position by clamping means on the main conductor. An electrically conducting coupling screw rotatable from outside cooperates with this block by means of a threaded borehole. The coupling screw can be placed in contact with the main conductor by rotation. The clamping means support the main conductor on their side facing away from the coupling screw. For each branch conductor, the contact block has a borehole for the reception thereof and a screw rotatable from outside for fixing this branch conductor in this borehole. The clamping means consist of two separate, more or less U-shaped, clamping parts which can be placed over the main conductor from two sides and are coupled to one another while enclosing the contact block.

EP 1088996 A2 discloses a securing element for a cylindrical component in a slot in a mechanical assembly. The slot is defined by two registration surfaces which meet at a vertex and a third surface which meets one of the registration surfaces. The slot receives the cylindrical component in contact with the two registration surfaces. The securing element comprises a surface in contact with the cylindrical component, a threaded engagement mechanism which secures the securing element to the assembly through a clearance hole in the securing elements and a protruding portion that ensures engagement and prevents rotation of the securing element by engagement with the third surface.

### SUMMARY

Teaching of the present disclosure include axle receptacles that avoid the disadvantages outlined above. For example, some embodiments include an axle receptacle (10) for fixing to an axle (20), in particular an axle (20) of an air flap (70), comprising a tension bracket (12) and a compression bracket (14) that can be moved by means of a drive shaft (30) relative to the tension bracket (12), wherein the drive shaft (30) is guided in a drive shaft guide (34) in the tension bracket (12), and wherein the drive shaft (30) and the drive shaft guide (34) function as a quick-action clamping apparatus in that the drive shaft (30) has a form-fitting contour (40) in or on its outer surface and the drive shaft guide (34) has a form-fitting mating contour (42) in or on its inner surface, characterized in that the form-fitting contour (40) and the form-fitting mating contour (42) can be brought into engagement with one another by rotating the drive shaft (30) and, as a result, the drive shaft (30) can be axially fixed in the drive shaft guide (34).

In some embodiments, sector threads (40, 42) function as the form-fitting contour (40) and form-fitting mating contour (42).

In some embodiments, the form-fitting contour (40) and the form-fitting mating contour (42) in each case have the sector thread (40, 42) at least in a region of 90° of the drive shaft circumference and 90° of the circumference of the drive shaft guide (34).

In some embodiments, the drive shaft (30) has the sector thread (40) in two drive shaft circumferential regions of 90° in each case that are radially opposite one another on the drive shaft (30), and the drive shaft guide (34) has the sector thread (42) in two shaft guide circumference regions of 90° in each case that are radially opposite one another in the drive shaft guide (34).

In some embodiments, the axle receptacle includes a locking screw (44) running concentrically with the drive shaft (30) in the drive shaft (30).

In some embodiments, the axle receptacle (10) includes a resetting apparatus for automatically triggering a return stroke of the compression bracket (14) when the form-fitting contour (40) and the form-fitting mating contour (42) are out of engagement.

In some embodiments, the resetting apparatus comprises a spiral spring (50) and a spring cage (52), the compression bracket (14) is attached to the spring cage (52), the spiral spring (50) is supported, on the one hand, on the outside of the tension bracket (12) and, on the other, on the inside of the spring cage (52) and a return stroke of the compression bracket (14) can be triggered by means of the spiral spring (50) and the spring cage (52) when the form-fitting contour (40) and the form-fitting mating contour (42) are out of engagement.

In some embodiments, the axle receptacle (10) has movable actuation protection which is effective when the form-fitting contour (40) and the form-fitting mating contour (42) are out of engagement.

In some embodiments, a telescopic protective shroud (54) functions as actuation protection, said telescopic protective shroud can be retracted into an actuating element (32) intended for rotating the drive shaft (30) when corresponding rotation of the drive shaft (30) causes the form-fitting contour (40) and the form-fitting mating contour (42) to enter into engagement and is extended into the actuation protection position when the form-fitting contour (40) and the form-fitting mating contour (42) are out of engagement.

In some embodiments, for the telescopic mobility of the protective shroud (54), the protective shroud has at least one helical guide link (62) in its inner surface in which guide link (62) a link block (60) of a base of a protective shroud (56) runs, and the protective shroud (54) can be rotated with the actuating element (32) and the base of the protective shroud (56) does not co-rotate when the actuating element (32) rotates.

As another example, some embodiments include an air flap rotary drive (74) with an axle receptacle (10) as described herein.

As another example, some embodiments include the use of an axle receptacle (10) as described herein for fixing an axle (20) of an air flap (70).

### BRIEF DESCRIPTION OF THE DRAWINGS

The figures show:

FIG. 1 an axle receptacle incorporating teachings of the present disclosure;

FIG. 2 a tension bracket of the axle receptacle including a drive shaft guide located there incorporating teachings of the present disclosure;

FIG. 3 a drive shaft of the axle receptacle with an actuating element at one end of the drive shaft incorporating teachings of the present disclosure;

FIG. 4 the axle receptacle according to FIG. 1 with an axle clamped by means of the axle receptacle;

FIG. 5 the tension bracket according to FIG. 2 and a section of the drive shaft according to FIG. 3 and the interaction of a form-fitting contour on the drive shaft and a form-fitting mating contour in the drive shaft guide;

FIG. 6 an example axle receptacle according to FIG. 1 with a resetting apparatus;

FIG. 7-10 details of an example axle receptacle according to FIG. 1 with actuation protection incorporating teachings of the present disclosure; and

FIG. 11 an axle receptacle on an axle of an air flap.

### DETAILED DESCRIPTION

The present disclosure describes axle receptacles provided for fixing to an axle, in particular an axle of an air flap. In some embodiments, the axle receptacle comprises a tension bracket and a compression bracket that can be moved by means of a drive shaft relative to the tension bracket. The drive shaft is guided in a drive shaft guide in the tension bracket. The special feature is that the drive shaft and the drive shaft guide function as a quick-action clamping apparatus.

As the drive shaft and the drive shaft guide function as a quick-action clamping apparatus, i.e., in that the drive shaft and the drive shaft guide are embodied to function as a quick-action clamping apparatus, the quick-action clamping apparatus can be used for the initial clamping of an axle to be fixed by means of the axle receptacle and also to release the fixing. Herein, the drive shaft is moved axially and only rotated to fix the quick-action clamping apparatus. There is no need for laborious multiple rotation of the drive shaft for the initial clamping of the respective axle. Thus, the respective axle is fixed much more quickly overall and the sequence of movement is thus easier and more comfortable for the respective operator. This also applies to releasing the fixing.

The drive shaft and the drive shaft guide function as a quick-action clamping apparatus in that the drive shaft has a form-fitting contour in or on its outer surface and the drive shaft guide has a form-fitting mating contour in or on its inner surface that matches the form-fitting contour in a form-fitting manner. Rotating the drive shaft enables the form-fitting contour and the form-fitting mating contour to be brought into engagement with one another (they are engageable with one another). As a result, the drive shaft can be axially fixed in the drive shaft guide and the drive shaft is axially fixed in the drive shaft guide when the form-fitting contour and the form-fitting mating contour are in engagement with one another.

In some embodiments, in each case a sector thread, for example a sector thread, which the drive shaft and the drive shaft guide in each case have at least in a region of 90° of the drive shaft circumference and 90° of the circumference of the drive shaft guide, functions as a form-fitting contour and form-fitting mating contour. The quick-action clamping apparatus and the corresponding axial mobility of the drive shaft enable quick initial clamping of an axle to be fixed and quick release of the fixing. For the final fixing of an axle clamped by means of the quick-action clamping apparatus, a locking screw running a concentrically with the drive shaft is provided in the drive shaft, which, for example, carries the compression bracket at its free end or which at least acts on the compression bracket with its free end.

In some embodiments, the axle receptacle has a resetting apparatus for automatically triggering a return stroke of the compression bracket, namely for triggering the return stroke when the form-fitting contour and the form-fitting mating contour are out of engagement. Such a return stroke triggered by means of a resetting apparatus causes an axle that was previously fixed by means of the axle receptacle to be immediately released again as soon as the form-fitting contour and the form-fitting mating contour are out of engagement.

In some embodiments, the resetting apparatus comprises a spiral spring and a spring cage, wherein the compression bracket is attached to the spring cage, wherein the spiral spring is supported, on the one hand, on the outside of the tension bracket and, on the other, on the inside of the spring cage and wherein a return stroke of the compression bracket can be triggered by means of the spiral spring and the spring cage when the form-fitting contour and the form-fitting mating contour are out of engagement. Such a resetting apparatus is mechanically comparatively simple, requires only a few parts and is sufficiently easy to assemble and handle during the production of the axle receptacle as well as during maintenance or possible repair of the axle receptacle.

In some embodiments, the axle receptacle has movable actuation protection which is effective when the form-fitting contour and the form-fitting mating contour are out of engagement. When the form-fitting contour and the form-fitting mating contour are out of engagement, the drive shaft is still axially movable. Initial clamping of the axle to be fixed in each case has not yet taken place (it is not even possible). In this situation, it should not be possible to actuate the locking screw intended for the final fixing of the axle. This is ensured by the actuation protection since this is only effective when the form-fitting contour and the form-fitting mating contour are out of engagement.

In some embodiments, a telescopic protective shroud functions as actuation protection which is retracted (can be retracted) into an actuating element intended for rotating the drive shaft when corresponding rotation of the drive shaft causes the form-fitting contour and the form-fitting mating contour to enter into engagement and to be finally engaged, and which is extended into the actuation protection position (extended position/telescoped position) when the form-fitting contour and the form-fitting mating contour are out of engagement. To provide its telescopic mobility, the telescopic protective shroud has at least one helical guide link in its inner surface in which a link block of a base of a protective shroud runs, wherein the protective shroud can be rotated with the actuating element and the base of the protective shroud does not co-rotate when the actuating element rotates.

In some embodiments, there are an air flap rotary drive with an axle receptacle as described here and in the following, as well as the use of such an axle receptacle for fixing an axle of an air flap. Independent of the grammatical term usage, individuals with male, female or other gender identities are included within the term. The following explains an exemplary embodiment of the axle receptacle proposed here in more detail with reference to the drawing. Corresponding objects or elements are provided with the same reference symbols in all figures.

The exemplary embodiments or each exemplary embodiment is not to be interpreted as restrictive. Rather, within the scope of the present disclosure, additions and modifications of the axle receptacle proposed here are possible, in particular those which, for example, by combining or modifying individual features or method steps described in conjunction with the features described in the general or specific part of the description and contained in the claims and/or the drawing, can be deduced by the person skilled in art with regard to achieving the object and, by means of combinable features, lead to new subject matter or new method steps or method step sequences.

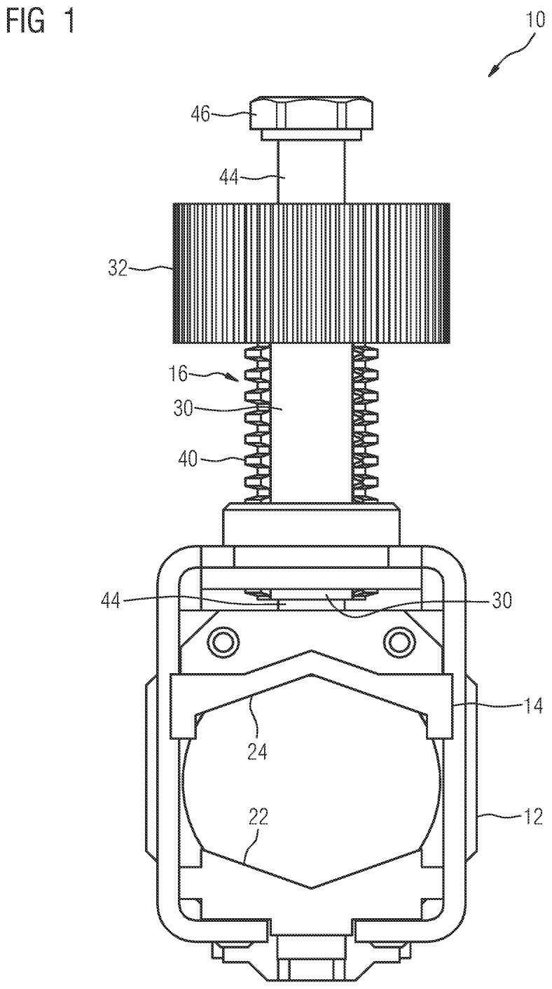

The depiction in FIG. 1 shows an example of an axle receptacle 10 incorporating teachings of the present disclosure. An axle receptacle 10 can also be referred to as an axle mount, axle adapter or shaft adapter. These or similar terms are synonyms. The designation axle receptacle 10 is used here and hereinafter.

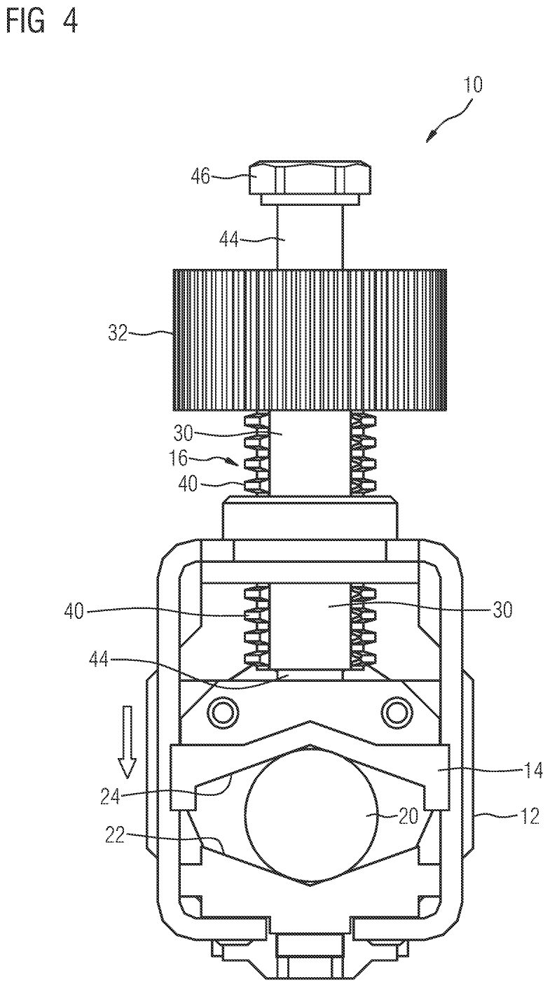

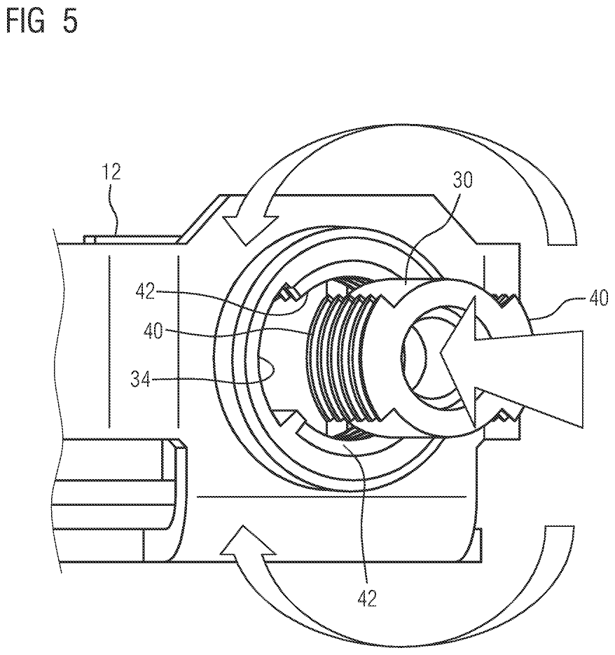

Axle receptacles 10 are typically intended for attachment to a rotatable axle 20 (FIG. 4), in particular an axle of an air flap or the like in a system for heating, ventilation, or cooling in a building. An axle receptacle 10 intended for attachment to such an axle 20 of an air flap or the like is part of an apparatus functioning as an air flap rotary drive or can be considered to be part of such an apparatus.

The axle receptacle 10 comprises several parts, hereinafter sometimes referred to individually or jointly as a component or components, namely a tension bracket 12, a compression bracket 14 and a compression bracket drive 16. The tension bracket 12 and the compression bracket 14 in each case have clamping jaws 22, 24 with grip sides facing each other. The grip sides of the clamping jaws 22, 24 are preferably V-shaped, so that axles 20 with different diameters can be gripped easily. The tension bracket 12 encloses an intermediate space in a housing-like manner.

The compression bracket 14 is translatorily movable in the tension bracket 12 and on the tension bracket 12. In a first direction of movement of the compression bracket 14, the two clamping jaws 22, 24 move toward one another and an axle 20 located between the clamping jaws 22, 24 is finally clamped by means of the clamping jaws 22, 24 and the gripping surfaces located there. In an opposite second direction of movement of the compression bracket 14, the two clamping jaws 22, 24 move away from one another and any axle 20 that was previously clamped by means of the clamping jaws 22, 24 is released.

The compression bracket 14 is translatorily movable in the tension bracket 12 and on the tension bracket 12 by means of the compression bracket drive 16. The compression bracket drive 16 comprises a drive shaft 30. The drive shaft 30 has at one end an actuating element (or: handle) 32 concentric therewith for actuating the compression bracket drive 16 and moving the compression bracket 14. To receive the drive shaft 30, the tension bracket 12 has a drive shaft guide 34.

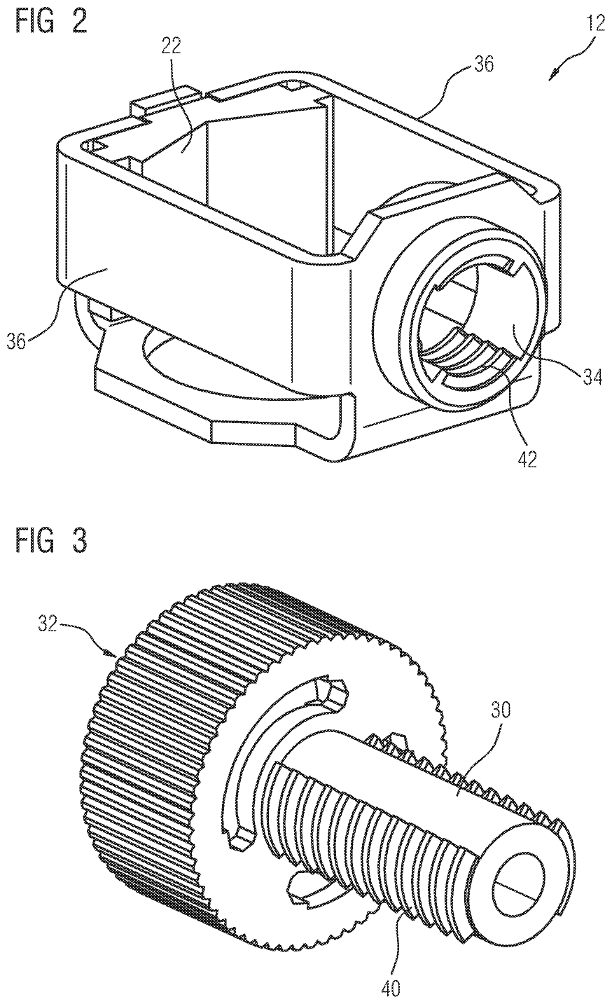

The depiction in FIG. 2 shows the tension bracket 12 with the drive shaft guide 34 and the depiction in FIG. 3 shows the drive shaft 30 with the actuating element 32 at one end thereof. The drive shaft guide 34 lies on the tension bracket 12 opposite to the clamping jaw 22 of the tension bracket 12. To connect these two sides of the tension bracket 12, the tension bracket 12 comprises connecting bridges 36, which also function as a guide for the compression bracket 14 and, together with two opposing outer sides of the compression bracket 14, form a plain bearing.

In the embodiment shown, a type of handwheel functions as an actuating element 32. The handwheel, which in the broadest sense, is cylindrical, is connected to the drive shaft 30, in particular integrally formed on the drive shaft 30, and has a larger diameter than the drive shaft 30 so that the handwheel can be easily gripped on its outer surface and rotated manually by an operator. The outer surface is, for example, preferably structured (as shown) corrugated, namely corrugated in the form of an external longitudinal corrugation.

The drive shaft guide 34 is intended and configured to receive and guide the drive shaft 30. The drive shaft 30 has a form-fitting contour 40 in or on its outer surface, for example (as shown) a form-fitting contour 40 in the form of or in the manner of a sector thread 40. In the interest of better legibility of the description presented here, but without sacrificing any further general validity, the term sector thread 40 is used in the following to designate the form-fitting contour 40 of the drive shaft 30 and with the same reference number. Herein, the more general designation as a form-fitting contour 40 should always be understood to be simultaneously applicable.

The term sector thread 40 refers first and foremost to a thread-like corrugation which, unlike a conventional thread, which runs continuously and helically/in a screw-like manner in a cylindrical shaft outer wall, is not continuous. The sector thread 40 has the thread-like corrugation in the region of at least one circular sector, i.e., for example in a region of 90° of the respective shaft circumference. The term sector thread 40 does not imply any restriction to a specific shaft circumference and the mention of 90° of the shaft circumference is expressly only an example. The term sector thread 40 also includes a radial pitch-free corrugation in the region of a circular sector, i.e., for example in a region of 90° of the shaft circumference.

For the drive shaft 30 and a sector thread 40 located there, it applies accordingly that the drive shaft 30 has the sector thread 40 in a region of 90° of the drive shaft circumference, for example. The drive shaft 30 can have the corrugation forming the sector thread 40 in exactly one circular sector or in a plurality of circular sectors, for example two circular sectors radially opposite one another on the drive shaft 30. It is essential that a drive shaft surface without corrugation adjoins a circular sector with corrugation on both sides.

Instead of corrugation, the drive shaft 30 can also have the elements of part of a bayonet lock. As is known, a bayonet lock is used to connect two cylindrical sections, the first of which has a knob and the second of which has an “L-slot” for receiving the knob, i.e., a formation with a longitudinal slot running in the axial direction and which is adjoined by a connecting slot extending approximately at right angles therefrom, at least initially. Instead of corrugation, the drive shaft 30 can therefore also have either at least one knob or at least one L-slot and the drive shaft guide 34 correspondingly has at least one L-slot or at least one knob. An L-slot or a knob is also only located in a specific region of the drive shaft circumference and the connection of two parts by means of a bayonet lock requires a thread-like rotation so that designation as a sector thread 40 is once again justified here. In any case, each example of a sector thread 40 is a form-fitting contour 40, namely a form-fitting contour 40 in or on the outer surface of the drive shaft 30, and the drive shaft guide 34 has a form-fitting mating contour 42 in or on its inner surface that is suitable for form-fit reception or form-fit contacting thereof.

A sector thread 42 likewise functions as a form-fitting mating contour 42, for example, as described above. If the sector thread 40 of the drive shaft 30 occupies, for example 90° of its (outer) circumference, the sector thread 42 of the drive shaft guide 34 can, for example, occupy 270° of its (inner) circumference; in practice, slightly less than 90° and slightly less than 270°. The above applies accordingly to the sector thread 42 of the drive shaft guide 34 (radial helical corrugation, radial pitch-free corrugation, bayonet lock).

In the embodiment shown, the drive shaft 30 has the sector thread 40 in two radially opposite drive shaft circumferential regions of 90° (in practice slightly less than 90°) on the drive shaft 30 in each case and the drive shaft guide 34 has the sector thread 42 in two radially opposite drive shaft guide circumference regions of 90° in each case (in practice slightly less than 90°) in the drive shaft guide 34. If the sector threads 40, 42 were previously out of engagement, a quarter turn (90° rotation) of the drive shaft 30 brings the sector threads 40, 42 fully into engagement.

The form-fitting contour 40 of the drive shaft 30 and the form-fitting mating contour 42 of the drive shaft guide 34 allow an axle 20 to be clamped quickly by means of the clamping jaws 22, 24. If the form-fitting contour 40 and the form-fitting mating contour 42 are out of engagement due to a corresponding rotation of the drive shaft 30, the drive shaft 30 is axially movable in the drive shaft guide 34. This mobility enables a forward stroke of the drive shaft 30 in the drive shaft guide 34 and, with this forward stroke, a forward stroke of the compression bracket 14 and the clamping jaw 24 on the compression bracket 14 until this clamping jaw 24 comes into contact with the outer surface of the axle to be fixed 20. If a rotation of the drive shaft 30 now brings the form-fitting contour 40 of the drive shaft 30 and the form-fitting mating contour 42 of the drive shaft guide 34 into engagement with one another, the drive shaft 30 is axially fixed in the drive shaft guide 34 with the clamping jaws 24 lying on the outer surface of the axle 20. In this configuration, the axle receptacle 10 is already initially attached to the axle 20. Herein, depending on the respective circumference of the axle 20 and likewise depending on the specific axial position of the drive shaft 30 after it has been axially fixed, the clamping jaws 22, 24 can already lie directly on the axle surface or can still be spaced apart from the axle surface. Both are referred to as clamping of the axle by means of the clamping jaws 22, 24 for the purpose of simple relationships for the description presented here. The final fixing of the axle 20 is described below.

With conventional fixing by means of a threaded spindle, the forward stroke of the compression bracket 14 and the clamping jaw 24 located there has to be achieved by rotating the threaded spindle many times, often a great many times. A drive shaft 30 and a drive shaft guide 34 with a form-fitting contour 40 and form-fitting mating contour 42 as described here, this forward stroke can be achieved by a quick linear movement of the drive shaft 30, namely an axial movement of the drive shaft 30. The rotation of the drive shaft 30 is limited to two rotations, which together form a maximum of one full rotation for the initial disengagement of the form-fitting contour 40 and the form-fitting mating contour 42 and the final engagement of the form-fitting contour 40 and form-fitting mating contour 42.

This mechanism is in principle known under a term such as, for example, “quick-action clamping apparatus” and the axle receptacle 10 proposed here is characterized by a quick-action clamping apparatus due to the drive shaft 30, the drive shaft guide 34 and the form-fitting contour 40 or form-fitting mating contour 42 located there.

The compression bracket drive 16 also comprises a locking screw 44. The locking screw 44 has an elongate shaft and, at one end of the shaft, a head 46 with an actuating contour, for example an actuating contour in the form of an internal hexagon, external hexagon or the like. The locking screw 44 has an external thread on its shaft. The drive shaft 30 has a central continuous axial borehole/axial recess with an internal thread that matches the external thread of the locking screw 44. The drive shaft 30 receives the locking 44; screw the locking screw 44 runs concentrically with the drive shaft 30 in the drive shaft 30. In other words: the locking screw 44 is/will be screwed into the drive shaft 30. The locking screw 44 bears the compression bracket 14 with its end opposite its head and, because the locking screw 44 is screwed into the drive shaft 30, the drive shaft 30 (at least indirectly) also bears the compression bracket 14.

The movement of the compression bracket 14 by means of the drive shaft 30 and the at least initial clamping of an axle 20 between the tension bracket and compression bracket 12, 14 has already been described (quick-action clamping apparatus). The final clamping of the axle 20 takes place by means of the locking screw 44 and the movement of the compression bracket 14 by means of the locking screw 44 then corresponds to a spindle drive that is in principle known per se. A direction in which the clamping jaws 22, 24 move toward one another, is designated the clamping direction; to clamp an axle 20, the compression bracket 14 moves in the clamping direction. The direction of movement opposite to the clamping direction is referred to as the opposite direction: when a previously clamped axle 20 is released, the compression bracket 14 moves in the opposite direction.

The depiction in FIG. 4 shows an axle 20 fixed by means of the axle receptacle 10. The axle 20 is clamped between the tension bracket 12 and the compression bracket 14 and the respective clamping jaws 22, 24. In comparison with the depiction in FIG. 1 and the situation shown there, the depiction in FIG. 4 shows the compression bracket 14 moved in the clamping direction. This movement of the compression bracket 14 takes place by means of the compression bracket drive 16, namely by an axial movement (“pushing”) of the drive shaft 30 in the drive shaft guide 34 and through the drive shaft guide 34. For this axial movement, the form-fitting contour 40 on the drive shaft 30 and the form-fitting mating contour 42 in the drive shaft guide 34 are out of engagement. The depiction in FIG. 4 also clearly shows the path traveled by the compression bracket 14 in the tension bracket 12. Due to the quick-action clamping apparatus, this path was possible without rotating the compression bracket drive 16. The final fixing of the axle 20 takes place by means of the locking screw 44 and by rotating the locking screw 44. The rotation of the locking screw 44 takes place in the drive shaft 30. For this purpose, the drive shaft 30 is axially fixed in the drive shaft guide 34. This is in turn achieved by bringing the form-fitting contour 40 on the drive shaft 30 and the form-fitting mating contour 42 in the drive shaft guide 34 into engagement with one another (by rotating the drive shaft 30 by means of the actuating element 32) so they are finally in engagement.

For a further explanation of the quick-action clamping process, the depiction in FIG. 5 shows the tension bracket 12 with a view of the drive shaft guide 34 located there and in alignment with the drive shaft guide 34 and, in front of the drive shaft guide 34, a section of the drive shaft 30. In the rotational position of the drive shaft 30 shown, the drive shaft can be recognizably introduced into the drive shaft guide 34 and is axially movable when inserted in the drive shaft guide 34 (indicated by the block arrow pointing in the axial direction of the drive shaft 30), because the form-fitting contour 40 on the drive shaft 30 and the form-fitting mating contour 42 in the drive shaft guide 34 are, and remain, out of engagement. For axial fixing of the drive shaft 30 in the drive shaft guide 34, the drive shaft 30 is rotated until the form-fitting contour 40 on the drive shaft 30 and the form-fitting mating contour 42 in the drive shaft guide 34 are in engagement with one another, in particular in full-surface engagement with one another. To cancel the axial fixing, for example, rotation takes place in the opposite direction until the form-fitting contour 40 on the drive shaft 30 and the form-fitting mating contour 42 in the drive shaft guide 34 are out of engagement. In the depiction in FIG. 5, the two rotations for the axial fixing of the drive shaft 30 and for cancelling the axial fixing are indicated by means of the two further block arrows. The directions of rotation depend on the respective embodiment of the form-fitting contour 40 and the form-fitting mating contour 42. In the case of corrugation with a pitch, the fixing takes place by means of rotation in a first direction and the cancelling of the fixing takes place by means of rotation in the opposite direction. In the case of corrugation without a pitch, fixing can likewise be cancelled by rotation in the opposite direction, but also by further rotation in the first direction. In the case of a form-fitting contour and 40 form-fitting mating contour 42 corresponding to a bayonet lock, rotation in the opposite direction is the only possibility for cancelling the fixing. The depiction in FIG. 5 shows the central axial borehole in the drive shaft 30 which receives the locking screw 44.

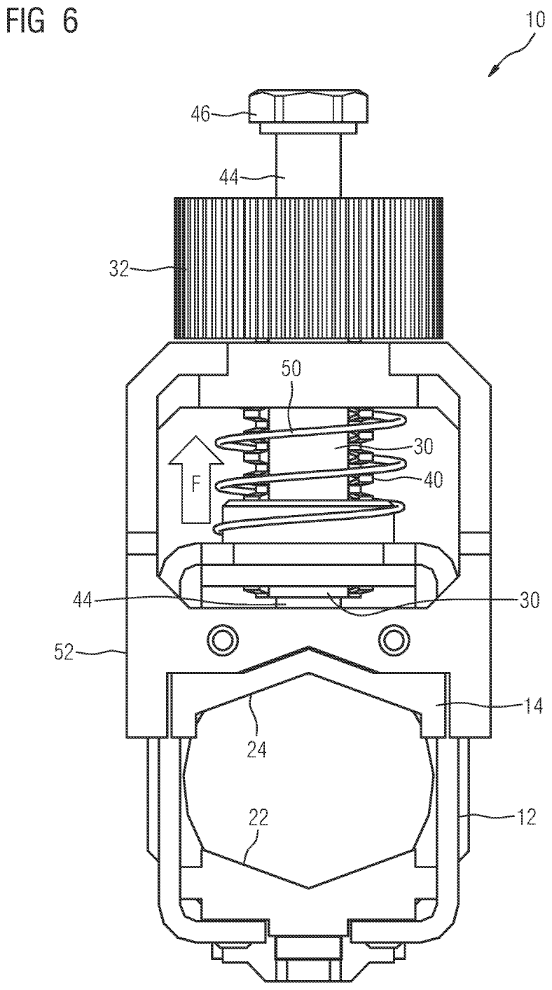

The depiction in FIG. 6 shows an embodiment of the axle receptacle 10 with an optional resetting apparatus. As described above, the quick-action clamping process is enabled due to the axial mobility of the drive shaft 30 in the drive shaft guide 34, provided that the form-fitting contour 40 on the drive shaft 30 and the form-fitting mating contour 42 in the drive shaft guide 34 are out of engagement. An actual axial movement of the drive shaft 30 and the associated forward stroke and return stroke of the compression bracket 14 requires the drive shaft 30 to be actively pushed or pulled by the respective operator. In the embodiment of the axle receptacle 10 with the resetting apparatus shown in the depiction in FIG. 6, the return stroke of the compression bracket 14 and the axial displacement of the drive shaft 30 in the drive shaft guide 34 required for this takes place automatically as soon as the form-fitting contour 40 and the form-fitting mating contour 42 are out of engagement.

The resetting apparatus comprises at least one spring element 50, for example (as shown) a spiral spring 50. The spiral spring 50 lies concentrically with the drive shaft 30 around the drive shaft 30 and lies with one end on the outside of the tension bracket 12 and with the opposite end, for example, on the underside of the actuating element 32. The spiral spring 50 clamps the actuating element 32 and thus the drive shaft 30 against the tension bracket 12. Without fixing the drive shaft 30 in the tension bracket 12 (in the drive shaft guide 34 located there) and without the action of an external force, the spiral spring 50 presses the actuating element 32 outward and thus effects a return stroke of the compression bracket 14. An alternatively possible resetting apparatus is two spiral springs (not shown) in the interior of the tension bracket 12 between the clamping jaws 22, 24 of the tension bracket and compression bracket 12, 14. Such spiral springs act in the same direction as the spiral spring 50 shown in FIG. 6 and are, for example, in each case placed on cones or mandrels provided on the outer ends of the clamping jaws 22, 24.

In the embodiment shown in FIG. 6, the resetting apparatus additionally comprises a spring cage 52. This encloses part of the compression bracket 14 and is translatorily movable along the compression bracket 14, wherein the respective sections of the compression bracket 14 and the spring cage 52 interact in a plain-bearing-like manner. The spring cage 52 is detachably connected to the compression bracket 14, for example, (as shown) by means of one or two pins on the compression bracket 14 which is or are received by corresponding recesses in the spring cage 52. The spring cage 52 also encloses the drive shaft 30 and for this purpose has a borehole or recess through which the drive shaft 30 passes. In the case of a spring cage 52, the spiral spring 50 is no longer supported (as mentioned above) on the underside of the actuating element 32 and on the inside of the spring cage 52. The spiral spring 50 is now supported, on the one hand, on the outside of the tension bracket 12 and, on the other, on the inside of the spring cage 52. The spiral spring 50 tensions the spring cage 52 and thus the drive shaft 30 against the tension bracket 12. Without fixing the drive shaft 30 in the tension bracket 12 (in the drive shaft guide 34 located there) and without the action of an external force, the spiral spring 50 presses the spring cage 52 outward and thus effects a return stroke of the compression bracket 14.

In the case of a spring cage 52 and in the case of a compression bracket 14 that is/can be attached to the spring cage 52, there is no need to mount the compression bracket 14 at the end of the locking screw 44. To fix an axle 20, it is then sufficient for the locking screw 44 to act on the compression bracket 14, i.e., for its shaft end to meet the compression bracket 14 when fixing an axle 20.

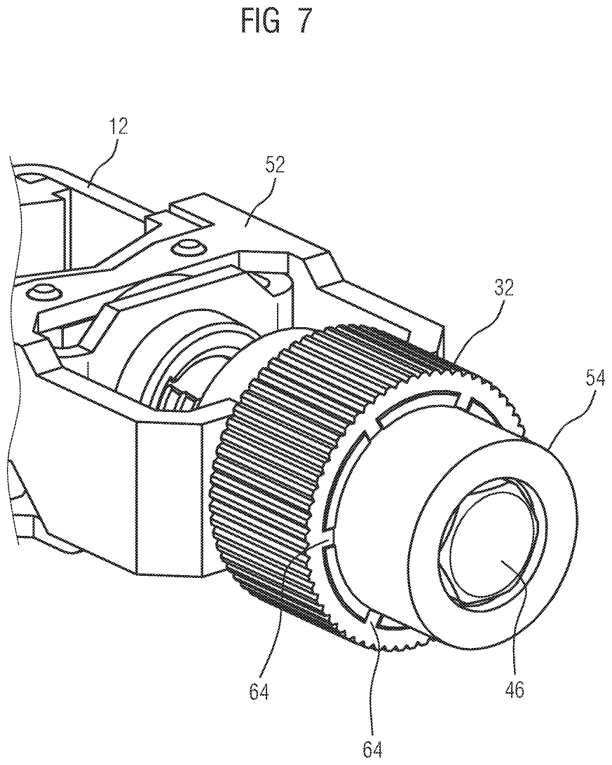

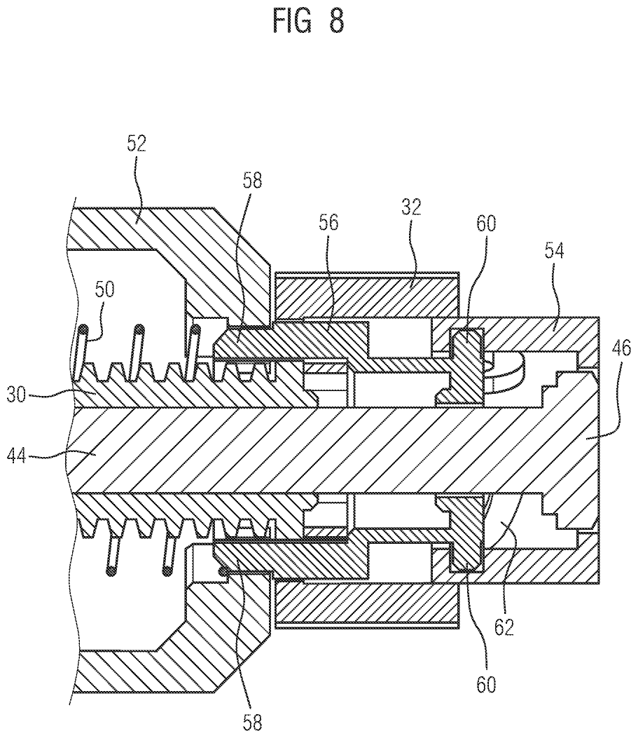

The depictions in FIG. 7 and FIG. 8 show an embodiment of the axle receptacle 10 with the optional resetting apparatus and with optional actuation protection, wherein a protective shroud 54 around the head 46 of the locking screw 44 functions as actuation protection. The depiction in FIG. 7 shows an isometric view of part of the axle receptacle 10 with a view of the head 46 of the locking screw 44, the actuating element 32 of the drive shaft 30 and, then, in this direction of view, the spring cage 52 and the tension bracket 12. The depiction in FIG. 8 shows a longitudinal section approximately through the region of the axle receptacle 10 shown in FIG. 7 with a sectional plane along the longitudinal axis of the drive shaft 30 (or of the locking screw 44 running in the drive shaft 30).

The protective shroud 54 is movably connected to a base of a protective shroud 56. The base of the protective shroud 56 is received by the (in the broadest sense) pot-shaped (cylindrical-jacket-shaped, open at one side/the top) actuating element 32 and, depending on the axial position, the protective shroud 54 is at least partially received by the actuating element 32. The base of the protective shroud 56 extends with at least one foot-like stop (foot 58) through a base of the actuating element 32 into the region of the spring cage 52. Advantageously, the base of the protective shroud 56 is axially fixed in that the foot or each foot 58 is latched with the spring cage 52, in particular in that the free end of the foot or each foot 58 or at least one foot 58 has a latching contour, for example a latching lug or a snap lock, and with the latching contour makes contact with a section of the recess in the spring cage 52 provided for receiving the respective foot 58. By means of the foot or each foot 58, the base of the protective shroud 56 is supported on the spring cage 52, so that, when the actuating element 32 is rotated, the base of the protective shroud 56 does not also rotate (the rotational position of the base of the protective shroud 56 remains the same even when the actuating element 32 is rotated).

The base of the protective shroud 56 ends on the side opposite the side with the at least one foot 58 in at least one pin-like stop 60 pointing radially outward, in two or more stops 60 distributed evenly along the circumferential line located there. In the region of the stop or each stop 60, a section of the base of the protective shroud 56 located there adjoins the locking screw 44 in an annular manner (without touching the outer surface of the locking screw 44, at least without touching the outer surface of the locking screw 44 on all sides).

The (in the broadest sense) cylindrical-jacket-shaped protective shroud 54 has in its inner surface one or more guide links 62, for example groove-shaped guide links 62, corresponding to the number of stops 60. The stop or each stop 60 in each case runs in a guide link 62 (therefore, the stop or each stop 60 can also be referred to as a link block 60). The guide link or each guide link 62 extends helically in the inner surface of the protective shroud 54.

The protective shroud 54 is connected to the actuating element 32 in a rotationally fixed manner but is axially moveable relative to the actuating element 32. Rotationally fixed means that a rotation of the actuating element 32 leads to a similar rotation of the protective shroud 54. In the embodiment shown, this rotationally fixed but axially movable connection is realized by means of a plurality of tongue-and groove form-fit connections (tongue-and-groove guides), wherein it is conceivable to reduce this to exactly one tongue-and-groove form-fit connection. In the embodiment shown, the protective shroud 54 has the corresponding grooves and the actuating element 32 has ribs (springs) 64 intended for form-fit engagement in the grooves.

Therefore, it should be noted that the base of the protective shroud 56 does not co-rotate when the actuating element 32 rotates and the protective shroud 54 does co-rotate when the actuating element 32 rotates. This and the connection of the base of the protective shroud 56 and the protective shroud 54 and the axial mobility of the protective shroud 54 during rotation of the actuating element 32 result in the retraction of the protective shroud 54 into the pot-shaped actuating element 32 during a rotation of the actuating element 32.

This retraction of the protective shroud 54 will now be considered in further detail for better understanding. When the actuating element 32 rotates, the orientation (rotational position) of the link block or each link block 60 is retained because the base of the protective shroud 56 does not rotate. When the actuating element 32 rotates, the protective shroud 54 co-rotates and the resulting rotation of the protective shroud 54 causes the guide link or each guide link 62 to slide over the respective link block 60 so to speak in a spiral-shape and the movement of the link block or each link block 60 along the respective guide link 62 causes the protective shroud 54 to be retracted.

When retracted, the protective shroud 54 releases the head 46 of the locking screw 44 and an actuating contour located there, namely an actuating contour in the form of an outer hexagon or the like. A tool can now be applied to the actuating contour and the locking screw 44 can be tightened for finally fixing an axle 20 clamped between the clamping jaws 22, 24.

Finally, the described retraction of the protective shroud 54 takes place due to a rotation of the actuating element 32. The drive shaft 30 is rotated by means of the actuating element 32 and a rotation of the drive shaft 30 brings the form-fitting contour 40 on the drive shaft 30 and the form-fitting mating contour 42 in the drive shaft guide 34 into or out of engagement with one another. The retraction of the protective shroud 54 due to a rotation of the actuating element 32 therefore takes place when the rotation of the actuating element 32 brings the form-fitting contour 40 and the form-fitting mating contour 42 into engagement with one another. The protective shroud 54 is retracted to the maximum extent when the form-fitting contour 40 and the form-fitting mating contour 42 are fully engaged with one another. Conversely, the protective shroud 54 is moved in the opposite direction, i.e., extended to a certain extent, namely extended into an actuation protection position, when the form-fitting contour 40 and the form-fitting mating contour 42 are brought out of engagement by a corresponding rotation of the actuating element 32 and the protective shroud 54 is extended to the maximum extent when the form-fitting contour 40 and the form-fitting mating contour 42 are out of engagement. When extended, the protective shroud 54 prevents actuation of the head 46 of the locking screw 44 with a tool. This justifies the designation of the extended state as an actuation protection position. Therefore, it is only possible for the locking screw 44 to be tightened when the form-fitting contour 40 and the form-fitting mating contour 42 are in engagement and thus the drive shaft 30 is axially fixed.

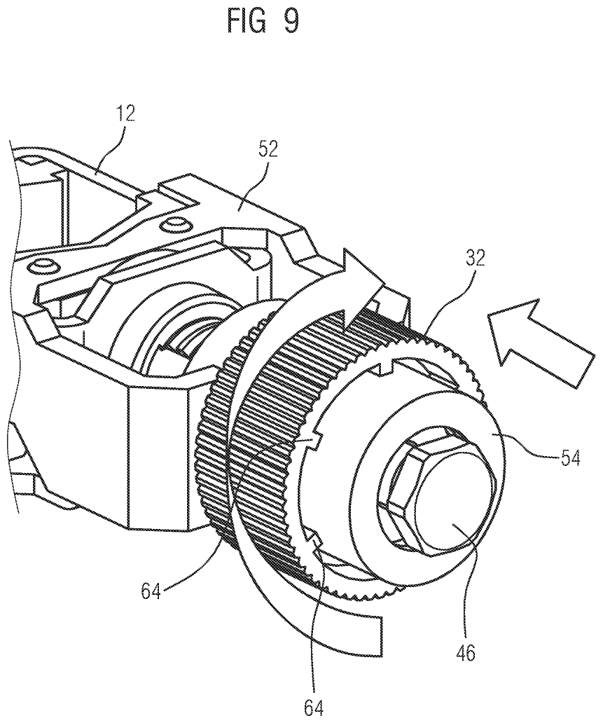

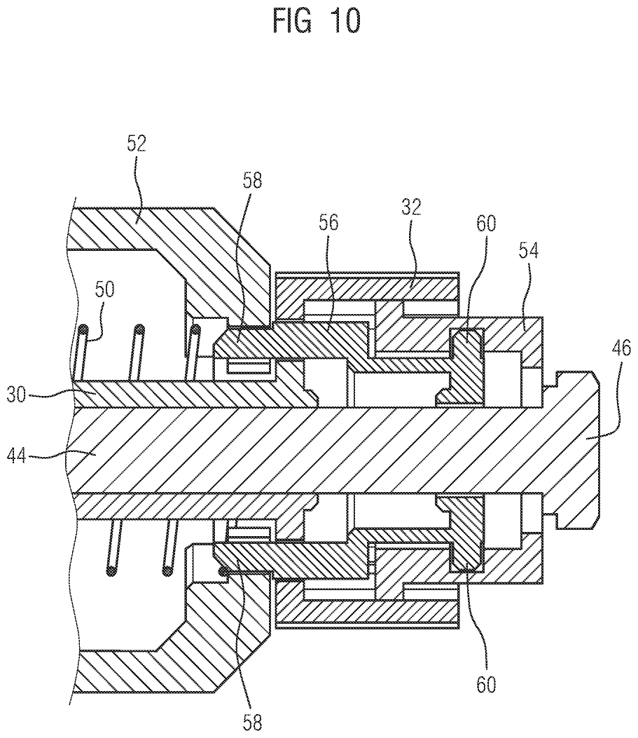

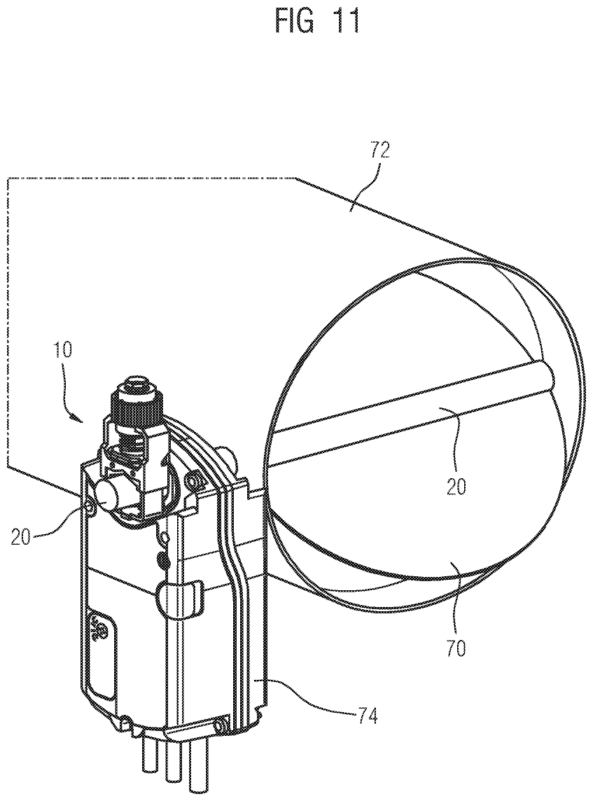

The depictions in FIG. 7 and FIG. 8 show the protective shroud 54 when it is extended to the maximum extent. The depictions in FIG. 9 and FIG. 10 show (in the same view as the depictions in FIG. 7 or FIG. 8) the protective shroud 54 when retracted to the maximum extent.

The depiction in FIG. 11 shows an axle receptacle 10 of the type proposed here (by way of example with the optional resetting facility, with the optional spring cage 52 and with the optional protective shroud 54) in a configuration provided for opening or closing an air flap 70. The air flap 70 is located in a pipe line, for example a ventilation pipe 72. The air flap 70 is connected in a known manner to an axle 20 and can be rotated by means of the axle 20. The axle 20 is clamped by means of the axle receptacle 10 and a rotation of the axle receptacle 10 effects a rotation of the axle 20 and thus a rotation of the air flap 70. The rotation of the axle receptacle 10 takes place in a manner that is known per se by means of a drive 74 provided for this purpose (air flap rotary drive), in particular a drive 74 in the form of an actuator.

Although the teachings herein have been illustrated and described in more detail by the exemplary embodiments, the scope of the disclosure is not restricted by the disclosed example or examples and other variations can be derived herefrom by the person skilled in the art without departing from the scope of protection thereof.

### List of Reference Characters

10 Axle receptacle
12 Tension clamp
14 Compression bracket
16 Compression bracket drive
18 (Free)
20 Axle
22 Clamping jaw
24 Clamping jaw
26, 28 (Free)
30 Drive shaft
32 Actuating element
34 Drive shaft guide, guide
36 Connecting bridge
38 (Free)
40 Form-fitting contour, sector thread
42 Form-fitting mating contour, sector thread
44 Locking screw
46 Head (of the locking screw)
48 (Free)
50 Spring element, spiral spring
52 Spring cage
54 Protective shroud
56 Base of protective shroud
58 Foot (foot-like stop at the base of the protective shroud)
60 Stop, link block
62 Guide link
64 Rib
66, 68 (Free)
70 Air flap
72 Ventilation pipe
74 Drive, air flap rotary drive

1. An axle receptacle for fixing to an axle of an air flap, the axle receptacle comprising:
a tension bracket;
a drive shaft guided in a drive shaft guide in the tension bracket; and
a compression bracket moved by the drive shaft relative to the tension bracket;
wherein the drive shaft and the drive shaft guide function as a quick-action clamping apparatus in that the drive shaft has a form-fitting contour in or on its outer surface and the drive shaft guide has a form-fitting mating contour in or on its inner surface;
the form-fitting contour and the form-fitting mating contour can be brought into engagement with one another by rotating the drive shaft and, as a result, the drive shaft can be axially fixed in the drive shaft guide.

2. The axle receptacle as claimed in claim 1, wherein the form-fitting contour and form-fitting mating contour both comprise sector threads.

3. The axle receptacle as claimed in claim 2, wherein the sector thread forms at least 90° of the drive shaft circumference and 90° of the circumference of the drive shaft guide.

4. The axle receptacle as claimed in claim 3,
wherein the drive shaft includes sector thread in two drive shaft circumferential regions of 90° in each case radially opposite one another on the drive shaft; and
wherein the drive shaft guide includes sector thread in two shaft guide circumference regions of 90° radially opposite one another in the drive shaft guide.

5. The axle receptacle as claimed in claim 1, further comprising a locking screw running concentrically with the drive shaft in the drive shaft.

6. The axle receptacle as claimed in claim 1, further comprising a resetting apparatus for automatically triggering a return stroke of the compression bracket when the form-fitting contour and the form-fitting mating contour are out of engagement.

7. The axle receptacle as claimed in claim 6, wherein:
the resetting apparatus comprises a spiral spring and a spring cage;
the compression bracket is attached to the spring cage;
the spiral spring is supported, on the one hand, on the outside of the tension bracket and, on the other, on the inside of the spring cage; and
a return stroke of the compression bracket can be triggered by the spiral spring and the spring cage when the form-fitting contour and the form-fitting mating contour are out of engagement.

8. The axle receptacle as claimed in claim 1, further comprising movable actuation protection effective when the form-fitting contour and the form-fitting mating contour are out of engagement.

9. The axle receptacle as claimed in claim 8, further comprising a telescopic protective shroud providing actuation protection;
wherein the telescopic protective shroud can be retracted into an actuating element intended for rotating the drive shaft when corresponding rotation of the drive shaft causes the form-fitting contour and the form-fitting mating contour to enter into engagement and is extended into the actuation protection position when the form-fitting contour and the form-fitting mating contour are out of engagement.

10. The axle receptacle as claimed in claim 9, wherein:
for the telescopic mobility of the protective shroud, the protective shroud has at least one helical guide link in its inner surface, the guide link including a link block of a base of the protective shroud; and
the protective shroud can be rotated with the actuating element and the base of the protective shroud does not co-rotate when the actuating element rotates.

11. An air flap rotary drive comprising:
an axle;
a tension bracket;
a drive shaft guided in a drive shaft guide in the tension bracket; and
a compression bracket moved by the drive shaft relative to the tension bracket;
wherein the drive shaft and the drive shaft guide function as a quick-action clamping apparatus in that the drive shaft has a form-fitting contour in or on its outer surface and the drive shaft guide has a form-fitting mating contour in or on its inner surface;
the form-fitting contour and the form-fitting mating contour can be brought into engagement with one another by rotating the drive shaft and, as a result, the drive shaft can be axially fixed in the drive shaft guide.
